(19) United States
(12) Patent Application Publication
(10) Pub. No.: US 2007/0289137 A1
(43) Pub. Date: Dec. 20, 2007

(54) PACKAGE OPENER

(76) Inventors: John Robert Egazarian, Marlborough, CT (US); Thomas Edward Brophy, Marlborough, CT (US); Robert M. Gallagher, Spencerport, NY (US); Douglas Dickerson Schumann, Middletown, CT (US); Gregory Lyon, Mamaroneck, NY (US); Raymond M. Schneider, Port Washington, NY (US)

Correspondence Address: MCCORMICK, PAULDING & HUBER LLP, CITY PLACE II, 185 ASYLUM STREET, HARTFORD, CT, 06103, US

(21) Appl. No.: 11/764,509

(22) Filed: Jun. 18, 2007

Related U.S. Application Data
(60) Provisional application No. 60/814,405, filed on Jun. 16, 2006.

(51) Int. Cl. B67B 7/00

(52) U.S. Cl. 30/2

(57) ABSTRACT

The present invention provides a package opener including an elongated body having a first cutting blade fixedly attached thereto and a second cutting blade rotatably coupled to the body adjacent the first cutting blade. The first and second cutting blades defining opposing first and second cutting edges respectively and movable relative to each other between open and closed positions. The first and second cutting blades cooperating in the open position to define a blade opening between the cutting edges thereof for receiving an object to be cut in a cutting process. The package opener including a lever attached to the second cutting blade for moving the second cutting blade towards the closed position, the lever biased for urging the second cutting blade towards the open position. The first and second cutting edges being disposed generally perpendicular to the length of the body.

### CROSS REFERENCE TO RELATED APPLICATIONS

This application claims priority to U.S. Provisional Patent Application No. 60/814,405 filed on Jun. 16, 2006 and titled “Utility Tool”. The disclosure of the provisional application is incorporated in its entirety herein by reference.

### FIELD OF THE INVENTION

The present invention generally relates to a package opener, and more particularly, to a package opener having a cutting blade for use in removing articles, such as toys, from packaging materials.

### BACKGROUND OF THE INVENTION

Manufacturers often secure new products within packaging materials using one or more ties manufactured from plastic, metal, fabric, or other materials, or combinations thereof. The ties are often tightly wrapped around the product and secured to the packaging material in an out of sight location. This practice is used extensively by toy manufacturers. Although this type of packaging may be very useful in protecting new products during transport or storage, or to deter unauthorized removal of the product from the packaging, the ties often make it difficult for a purchaser of the product to remove the product from the packaging.

A new product may be partially visible through an opening or clear portion of the packaging material, yet secured tightly thereto via one or more ties. Even products that are not visible through their packaging materials often include ties securing the product to packaging materials for the product. Often, the ties surround the product and extend through a portion of the packaging material and are secured either to the packaging material or include opposing ends twisted or tied together around the packaging material in such a way that the connection between the ties and the packaging material is inaccessible and/or difficult to loosen or remove. Sometimes tape or even small fasteners such as screws, are also used to secure packaging materials together or attach ties or products to the packaging materials.

Accordingly, it can be a challenging task for a consumer to remove a toy or other product from packaging materials including ties such as those described above. Usually the ties are manufactured from a material which cannot easily be broken without the use of some type of a cutting tool. For example, the ties may include a plastic or fiber outer layer surrounding a wire core. In many cases, untwisting or otherwise releasing the ties from the packaging material may not be feasible without a cutting tool, as the ties are often secured in a position where the ends of a tie are tightly twisted together, or a connection between the tie(s) and the packaging material is not readily accessible. Further, the tape often used with packaging materials may appear flimsy yet can also be difficult to cut or break without a cutting tool. An unpackaging project can become even more challenging if an impatient child is overlooking the task, or a number of products need to be removed from similar types of packaging materials at the same time.

Typically, consumers faced with a task of removing a new toy or other product from the packaging materials in which they are packed often choose an ordinary pair of scissors for use in an attempt to cut ties or packaging material so that the toy or other products can be removed from the associated packaging materials. Scissors, however, are often not effective for cutting packaging ties such as those described above. Small scissors usually will not cut through the ties and larger scissors are often difficult to position for cutting a tie without a risk of damaging the products. Moreover, scissors designed to cut paper or cardboard can be bent or otherwise damaged when used to cut packaging ties, especially those including a wire strand or core. Further, scissors are often not effective for cutting a tie or other object positioned between the ends of the tip of the scissors. Thus, to cut a packaging tie with scissors it is easier to slide the tie substantially into the opening between the blades of the scissors, however, this increases the risk of damaging the product with the tips of the scissors. Further, this type of positioning may require a user of the scissors to contort his/her wrist or arm in an awkward position during the cutting process.

Additionally, a screw driver is often useful in removing packaging materials or installing batteries in new products. Usually a consumer must therefore have at least a pair of scissors or another cutting tool as well as a screwdriver available to unpackage and/or install batteries in new products including many currently popular toys.

Based on the foregoing, it is the general object of the present invention to provide a package opener that improves upon, or overcomes the problems and drawbacks associated with the prior art.

### SUMMARY OF THE INVENTION

The present invention provides a package opener including an elongated body having a first cutting blade fixedly attached thereto and a second cutting blade rotatably coupled to the body adjacent the first cutting blade. The first and second cutting blades defining opposing first and second cutting edges respectively and movable relative to each other between open and closed positions. The first and second cutting blades cooperating in the open position to define a blade opening between the cutting edges thereof for receiving an object to be cut in a cutting process. The package opener including a lever attached to the second cutting blade for moving the second cutting blade towards the closed position, the lever biased for urging the second cutting blade towards the open position. The first and second cutting edges being disposed generally perpendicular to the length of the body thereby forming a generally rectangular opening therebetween. A spring disposed between an interior surface of the body and the lever urges the lever away from the body and, via the lever, the second cutting blade towards the open position.

In one embodiment of the present invention, the blade opening between the first and second cutting edges is in a range of about two millimeters to about five millimeters in the open position. The second cutting blade being housed entirely within the body in the open position such that the cutting edge on the second cutting blade is extended exterior a cavity in the body only when the cutting blades are in a closed position.

Accordingly, the package opener of the present invention provides a compact tool for use in removing toys and other objects from packaging materials used for shipping and/or storage of the goods. The package opener provides for the quick and efficient severing of packaging ties typically used to secure goods such as toys to associated packaging materials. Additionally, the package opener includes a tape cutter coupled to the body thereof for severing tape typically used to secure goods to the associated packaging materials in which they are packed, stored and shipped. Further the present invention includes a screwdriver which can also be useful in removing toys and other goods from packaging materials or for installing or removing batteries from battery powered devices.

In another aspect, the present invention package opener includes means for cutting open a typical blister package as set forth further herein below.

The foregoing and still other objects and advantages of the present invention will be more apparent from the description of the preferred embodiments of the invention in connection with the accompanying drawings.

### BRIEF DESCRIPTION OF THE DRAWINGS

FIG. 1 is an side elevational view of one embodiment of a package opener according to the present invention shown with a small piece of a wire tie between the cutting blades thereof.

FIG. 2 is a side sectional view of the package opener of FIG. 1.

FIG. 3 is an exploded perspective view of the package opener of FIG. 1.

FIG. 4 is an elevational view of the package opener of FIG. 1 shown with the first and second cutting blades thereof shown in a closed position.

FIG. 5 is a bottom view of the package opener of FIG. 1.

FIG. 6 is a front view of the package opener of FIG. 1 showing a tape cutter mounted to a forward end of the package opener.

FIG. 7 is a perspective view of the package opener of FIG. 1.

FIG. 8 is a side elevational view the package opener of FIG. 1 shown with the cutting blades thereof in a closed position and inverted as used in cutting or scoring a typical blister package.

### DETAILED DESCRIPTION OF THE INVENTION

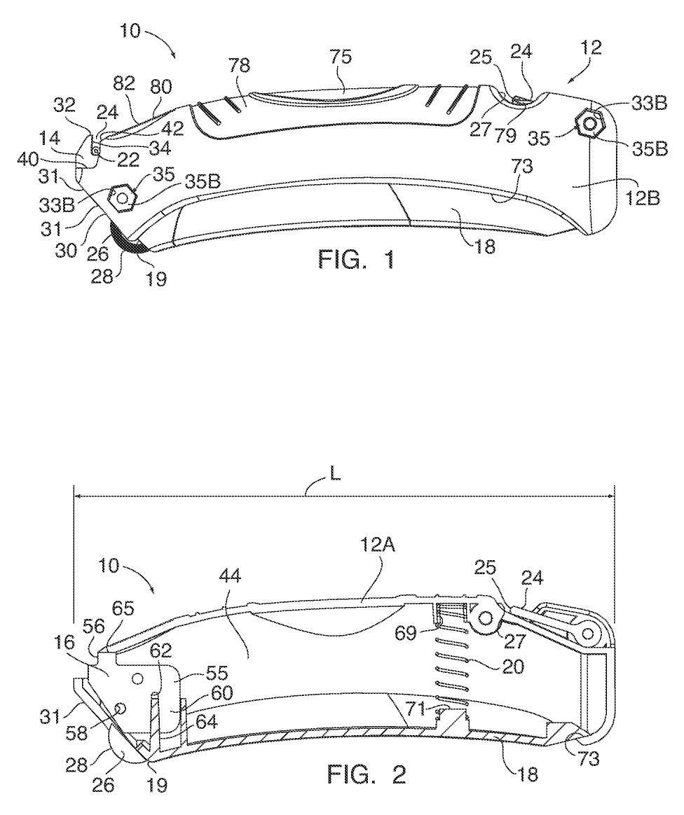

As shown in FIG. 1, the present invention is directed to a package opener generally designated by the reference number 10 having a body 12 and a first cutting blade 14 fixedly attached to the body. A second cutting blade 16 (See FIG. 2) is rotatably coupled to the body 12 for movement between open and closed positions relative to the first cutting blade 14 and the body 12. A lever 18 is attached to the second cutting blade 16 for moving the second cutting blade towards the closed position. A spring 20 (See FIG. 2) coupled between the body 12 and the lever 18 urges the lever away from the body and, via the lever 18, the attached second cutting blade 16 towards the open position. A small piece of wire tie 22 is shown in FIG. 1 positioned in a blade opening 24 defined between the first and second cutting blades 14 and 16 when the blades are in the open position.

Still referring to FIG. 1, the package opener 10 includes a screwdriver 24 rotatably coupled to the body 12 for movement between working and storage positions. FIG. 1 shows the screwdriver 24 in the storage position wherein a tip 25 of the screwdriver is disposed in a cavity 27 defined by the body 12. In a working position, the screwdriver 24 is rotated away from the body 12 so that the tip thereof is engageable with a screw (not shown). A tape cutter 26 defines a serrated cutting edge 28 extending outwardly from a nose end 30 of the body 12. In the illustrated embodiment, the tape cutter 26 is formed integrally with the body 12. In other embodiments, the tape cutter 26 can be formed separately from the body 12 and attached thereto.

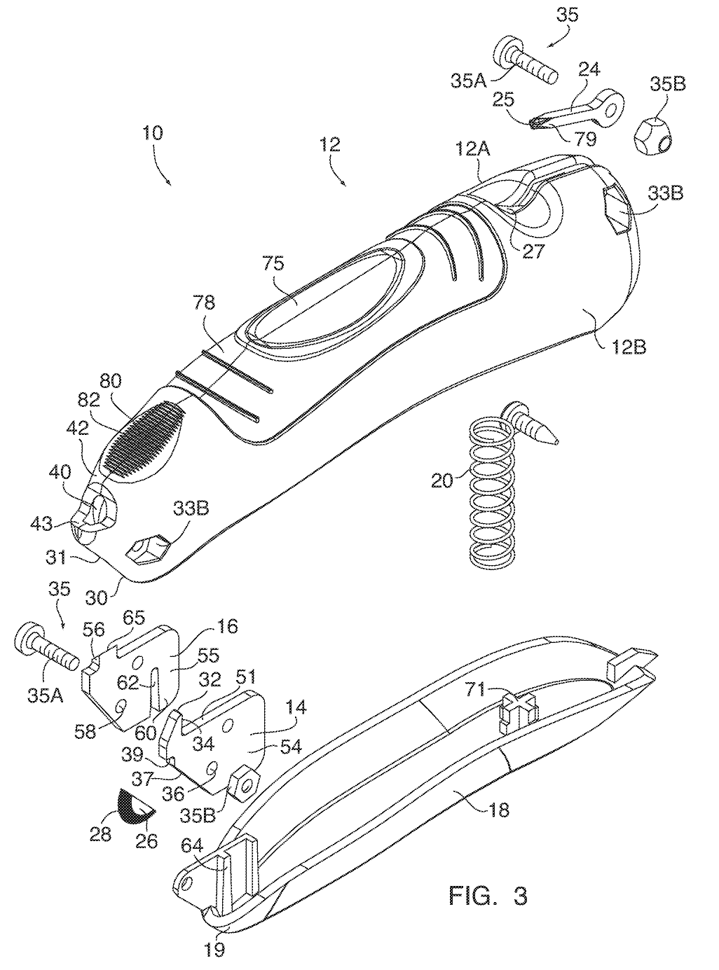

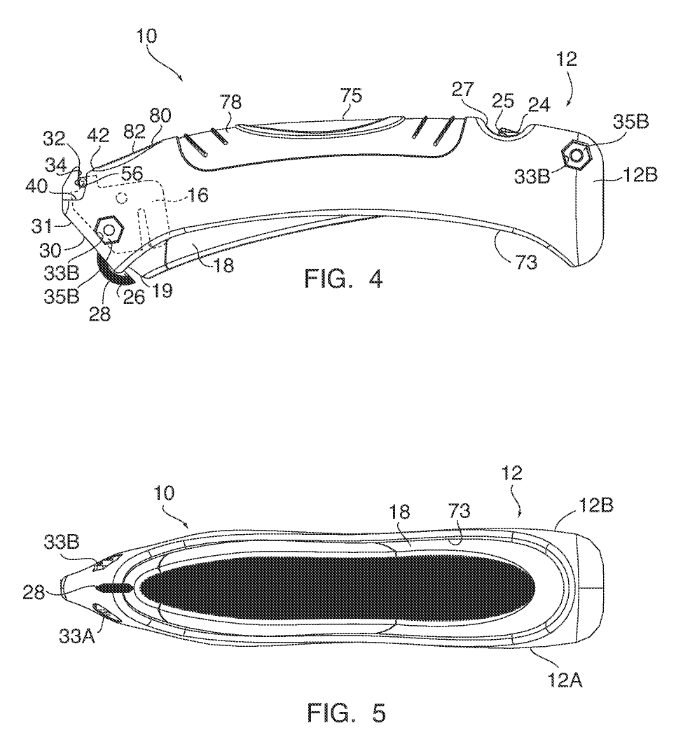

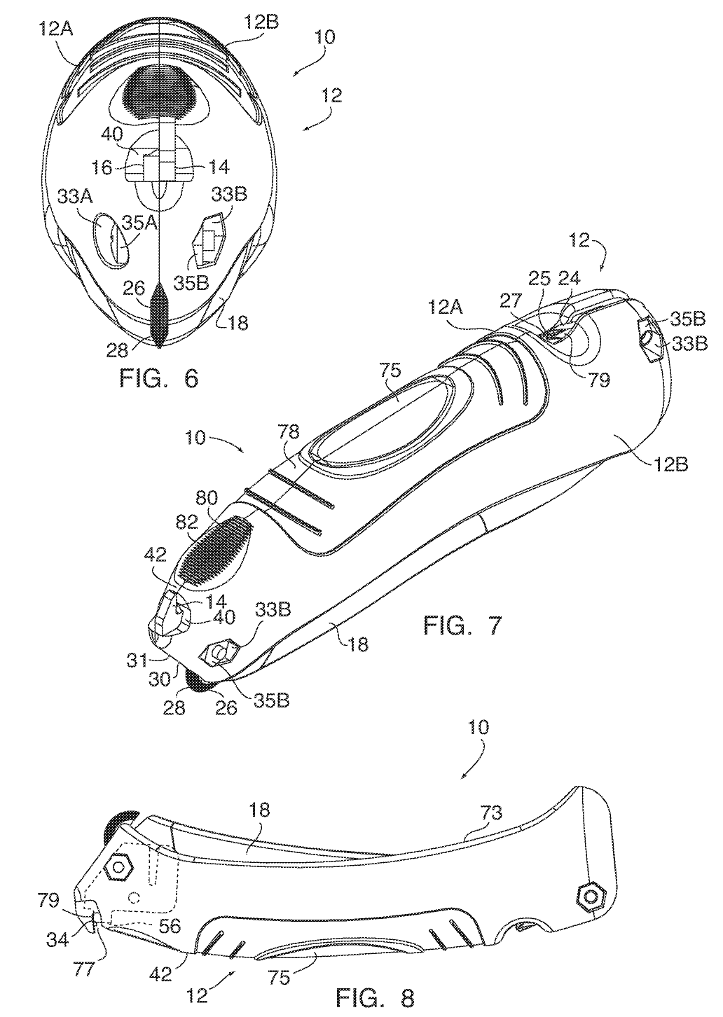

Referring to FIGS. 2 and 3, the body 12 includes a pair of split body portions 12A and 12B which are substantially mirror images of one another and cooperate to form the body 12 when coupled together. The body portions 12A and 12B are manufactured from plastic and define a plurality of openings 33A and 33B respectively, for receiving fasteners 35 for connecting the body portions together. The fasteners 35 each include a screw 35A and a corresponding nut 35B which are connectable, one to the other, in a well known manner for attaching the body portions 12A and 12B together. As shown in the figures, the body portion 12A defines a plurality of screw openings 33A configured for receiving the screw 35A and the body portion 12B defines a plurality of corresponding nut openings 33B for receiving the nuts 35B therein. The nut openings 33B are hexagonally shaped such that the nuts 35B cannot rotate within the nut openings. Alternatively, the fasteners 35 can be formed as rivets designed not be separated once the body portions 12A and 12B are coupled together. In another embodiment of the present invention, the body portions 12A and 12B define cooperating plastic couplers, wherein a portion of each of the couplers is formed integrally with one of the body portions 12A and 12B for connecting the two body portions together.

Still referring to FIGS. 2 and 3, the first cutting blade 14 defines a cutting tip 32 extending outwardly from a lower portion 54 of the cutting blade. The cutting tip defines a cutting edge 34 disposed generally perpendicular to a length L of the body 12. A hole 36 is defined by the first cutting blade 14 for receiving one of the screws 35A therethrough for securing the position of the first cutting blade 14 relative to the body portion 12A. The body portions 12A and 12B cooperate to define a notched opening 40 in a corner of the body 12 formed at the intersection of a forward end 30 and an upper surface 42 of the body 12. In assembly, the body portions 12A and 12B define a cavity 44 therebetween for receiving the first and second cutting blades 14 and 16 respectively. The first cutting blade 14 is mounted substantially inside of the cavity 44 and disposed near the forward end 30 of the body 12. The forward end 30 of the body 12 is angular having a surface 31 disposed at an angle theta of about 45 degrees relative to an axis X defined generally along the length of the body 12 as shown in FIG. 2. The angled forward end 30 is provided to facilitate placing the cutting tip 32 of the first cutting blade under and/or behind packaging ties 22 which may be secured tightly to, or adjacent associated packaging material. In other embodiments of the package opener 10, the forward end 30 is disposed at an angle in a range of about 30 degrees to about 90 degrees relative to the axis X defined generally along the length of the body 12.

The first blade 14 defines a forward edge 37 which is also angled and conforms with the angled shape of the forward end 30 of the body 12. The cutting tip 32 of the first cutting blade 14 extends through the notched opening 40 formed in the body 12 and beyond the upper surface 42 of the body so that the tip 32 is easily positionable rearward of ties 22 to be severed by the package opener 10. The cutting tip 32 of the first cutting blade extending beyond the upper surface 42 of the body 12 also facilitates positioning a tie 22 to be severed in the cutting opening 24 and tends to draw the tie into the cutting opening when the forward end 30 of the package opener is rotated toward the tie. Thus, the package opener 10 can be operated with one hand to place the tie 22 in the cutting opening 24 using the cutting tip 32 and sever the tie via squeezing the lever 18 thereby moving the lever towards and partially into a bottom opening 73 defined by the body 12. Further, during a cutting operation, the extended cutting tip 32 of the first cutting blade 14 tends to prevent the tie 22 being severed from moving out of the cutting opening 24 during a cutting process.

The cutting blade 14 further defines a shoulder 39 which engages and is supported by a surface 43 of the forward end 30 of the body 12 which in part defines the notched opening 40. The cutting tip 32 of the first cutting blade 14 extends through the notched opening 40 of the body 12 and is supported opposite the cutting edge 34 by the shoulder 39 bearing on the surface 43 of the forward end 30 of the body 12.

The first cutting blade 14 further defines a second cutting edge 51 disposed approximately perpendicular to the cutting edge 34 and generally parallel to the axis X. The intersection of the cutting edge 34 and the second cutting edge 51 provides a corner for receiving a wire tie 22 or other object to be severed using the package opener 10. As set forth above, the shoulder 39 backs up, or provides a counter pressure surface for the first cutting blade against the body 12 during a cutting operation. The first cutting blade 14 is secured to the body portion 12A via the screw 35A engaging the hole 36 defined by the first cutting blade 14. Additionally, the body portion 12A may include additional protrusions or clips to engage an edge of the first cutting blade 14 and secure the position of the first cutting blade relative to the body portion. An adhesive or additional fastener can also be utilized to attach the first cutting blade 14 to the body portion 12A.

Still referring to FIGS. 2 and 3, the second cutting blade 16 is shaped substantially similar to the first cutting blade 14 including a generally rectangular lower portion 55 and a cutting tip 56 extending outwardly from the lower portion at approximately a right angle thereto. The lower portion defines a hole 58 for receiving the screw 35A which extends through the second cutting blade 16 such that the second cutting blade is disposed in the cavity 44 adjacent the first cutting blade 14. The hole 58 in the second cutting blade 16 is dimensioned such that the second cutting blade is rotatable about the screw 35A relative to the first cutting blade 14 in a cutting process. The lower portion 55 defines an end 60 opposite the hole 58 which is attached to a forward end 19 of the lever 18. In the illustrated embodiment, the second cutting blade 16 defines a slot 62 in the lower portion thereof which receives a corresponding protrusion 64 extending outwardly from the forward end 19 of the lever 18. The slot 62 and the protrusion 64 are oriented generally orthogonal to an axis of the screw 35A for rotating the second cutting blade 16 about the screw 35A via the lever 18. In other embodiments, a second screw (not shown) is used for securing the second cutting blade 16 to the lever 18.

The cutting tip 56 defines a cutting edge 65 disposed generally parallel to the cutting edge 34 on the first cutting blade 14 and spaced apart therefrom. The blade opening 24 is defined between the opposing cutting edge 34 on the first cutting blade 14 and the cutting edge 65 on the second cutting blade 16. As shown on FIG. 1, the blade opening 24 defined in part by the opposing cutting edges 34 and 65 is generally rectangular in shape. A lower edge of the blade opening 24 being defined by the upper edges of the adjacent lower portions 55 of the first and second cutting blades 14 and 16 respectively. In a preferred embodiment a width of the blade opening 24 measured between the opposing cutting edges 34 and 65 is approximately two millimeters. In the above-identified embodiment, the width of the blade opening 24 is designed to receive wire ties 22 to be severed having a cross-section up to 2 millimeters. In other embodiments, the width of the blade opening 24 is in a range of about two millimeters to about five millimeters.

Still referring to FIGS. 2 and 3, a compression spring 20 is disposed between an interior surface of the body 12 and the lever 18 for urging the lever away from the body. The body portions 12A and 12B cooperate to define an opening 69 for receiving an end of the spring 20 therein and securing the position of an end of the spring relative to the body 12. Similarly, the lever 18 defines a spring base 71 for receiving an opposing end of the spring 20 and fixing the position of the spring relative to the lever. Via the lever 18, the spring 20 causes the second cutting blade 16 to be urged towards the open position or normal position wherein the cutting edges 34 and 65 are spaced apart from each other for receiving an object to be cut in the blade opening 24 therebetween. Thus, the spring 20 is configured to urge the second cutting blade 16 towards the open position via a rearward end of the lever 18 being pushed away from the body 12.

Referring to FIG. 7, the package opener 10 is shown with the first and second cutting blades 14 and 16 respectively in the closed position. In the closed position, the rearward end of the lever 18 is moved towards the body portion 12 against the spring 20 such that a portion of the lever extends into a bottom opening 73 defined by the body 12. In the closed position, the cutting edge 65 of the second cutting blade 16 is rotated towards the first cutting blade 14 and past the cutting edge 34 thereof such that the blade opening 24 is closed.

The package opener 10 includes a grip portion 75 which can be formed separately of the body 12 of a rubber or foam material for providing a comfort grip for a user of the utility tool. The grip portion 75 is adhered to the body 12 or connected thereto via plastic fasteners (not shown). Alternatively, the grip portion 75 is formed integrally with the body 12 and defines a textured surface 78 for enhancing the gripability thereof.

Additionally, the upper surface 42 of the body 12 defines a thumb grip 80 formed near the forward end 30 of the body for engaging the underside of a user's thumb when the package opener 10 is gripped in a hand of the user. In the illustrated embodiment, the thumb grip 80 is defined by the body 12 of the package opener 10 and formed integrally therewith. As shown, the body 12 defines a knurled or finely serrated engagement surface 82 for ensuring a firm engagement between a forward end of the upper surface 42 of the package opener 10 and a user's thumb.

In use as a cutting tool, the package opener 10 of the present invention can be grasped in one hand of a user such that the user's fingers engage the lever 18 on the underside of the package opener and a surface of the palm of the hand engages the upper surface 42 of the utility tool. The package opener 10 being oriented in the user's hand such that the forward end of the tool is near the thumb end of the hand. The underside of the user's thumb can be positioned on the engagement surface 82 defined by the upper surface 42 of the body 12. The package opener 10 can then be used to unwrap or remove a toy or other object from packaging material associated with the toy or object. The package opener 10 can then be used to unwrap or remove a toy or other object from packaging material associated with the toy or object.

To cut a tie 22, the forward end of the package opener 10 is positioned to engage the tie such that the tie is positioned in the cutting opening 24 while the first and second cutting blades 14 and 16 are in the open position. In a cutting process, the second cutting blade 16 is rotated via the lever 18 towards the closed position such that a tie 22 or other object occupying the blade opening is severed between the opposing cutting edges 65 and 34 as the cutting edge 65 of the second cutting blade 16 moves past the adjacent cutting edge 34 of the first cutting blade 14. Thus, the cutting process is performed by first placing a wire tie 22 in the blade opening 24 and then squeezing the lever 18 such that the lever is moved toward the body 12 and the tie is severed between the first and second cutting blades 14 and 16 respectfully. The wire tie 22 positioned in the blade opening 24 is severed by the opposing cutting edges 34 and 51 of the first cutting blade and the cutting edge 65 of the second cutting blade. Releasing the lever 18 allows the cutting blade 16 to return to the open position due to the force of the spring 20 urged against the lever 18.

Tape can be cut easily by engaging the cutting edge 28 of the tape cutter 26 with the tape for severing the same. If the tape is taut, engaging the cutting edge 28 against the tape with a slight force will normally sever the tape. For cutting stronger tape, a back and forth cutting motion moving the cutting edge 28 across a surface of the tape may be necessary to sever the tape. In the illustrated embodiment, the tape cutter 26 includes a pair of opposing arcuate cutting edge 28 extending outwardly from the forward edge 30 of the body 12. The cutting edges 28 are tapered towards each other defining a cutting edge 29 at an intersection of the outer edges thereof.

Referring to FIG. 8, the package opener 10 is designed to cut open a blister package by placing the package opener in an inverted position in a hand of a user such that the fingers of the user's hand engage the upper surface 42 and grip portion 75 of the package opener. The lever 18 disposed adjacent the palm and thumb of the user's hand. In this position, the lever 18 can be squeezed moving the lever towards the body portion and partially extending into the bottom opening 73 therein such that the first and second cutting blades 14 and 16 are in the closed position. A surface of a package such as a blister package can then be cut by placing an edge of the packaging material in the notched opening 77 formed between the cutting edge 34 of the first cutting blade 14 and a cutting edge 79 defined by the cutting tip 56 of the second cutting blade. (See FIG. 3) and moving the package opener 10 in the direction of the desired cut. Alternatively, the material to be cut can first be pierced using the cutting tip 32 of the first cutting blade 14 and then sliced by positioning the material to be cut in the notched opening 77 as set forth above and then moving the package opening in the direction of the desired cut. Further, the package opener 10 can also be used to score a material by positioning the package opener in a hand of the user in the inverted position as set forth above, and scoring a material by engaging the tip 32 of the first cutting blade with the material to be scored and moving the package opener in the direction of a desired score line.

The screwdriver 24 of the package opener 10 is used by gripping the body 12 in one hand of a user such that the user's fingers engage the lever 18 on the underside of the package opener and a surface of the palm of the hand engages the upper surface 42 and the grip portion 75 of the package opener. The package opener 10 being oriented in the user's hand such that the screwdriver end 79 of the tool is near the thumb end of the user's hand. The screwdriver 24 can be extended to the working position by moving the shaft and tip 25 of the screwdriver away from the body 12 and into the working position. The tip 25 of the screwdriver can be engaged with the head of a screw to be installed or removed and the body 12 of the package opener 10 rotated to turn the screw.

The foregoing description of embodiments of the invention have been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A package opener comprising:
an elongated body having a first cutting blade fixedly attached thereto,
a second cutting blade movably coupled to the body adjacent the first cutting blade,
the first and second cutting blades defining opposing first and second cutting edges respectively,
the first and second cutting blades movable relative to each other between open and closed positions,
the first and second cutting blades cooperating in the open position to define a blade opening between the cutting edges thereof for receiving an object to be cut in a cutting process,
a lever attached to the second cutting blade for moving the second cutting blade towards the closed position,
the lever biased for urging the second cutting blade towards the open position,
the first and second cutting edges being disposed generally perpendicular to the length of the body.

2. The package opener in accordance with claim 1 wherein the blade opening between the first and second cutting edges is in a range of about two millimeters to about five millimeters in the open position.

3. The package opener in accordance with claim 1 wherein the blade opening between the first and second cutting edges is generally rectangular in shape.

4. The package opener in accordance with claim 1 wherein the opening between the first and second cutting edges is about two millimeters in the open position.

5. The package opener in accordance with claim 1 further comprising a screwdriver.

6. The package opener in accordance with claim 1 wherein the second cutting blade is housed entirely within a cavity defined by the body in the open position.

7. The package opener in accordance with claim 1 further comprising biasing means urging the lever away from the tool body and the second cutting blade towards the open position.

8. The package opener in accordance with claim 1 wherein the body includes the first and second cutting blades coupled to the body near a forward end thereof, the forward end of the body defining a surface disposed at an angle of about 45 degrees relative to an axis defined generally along the length of the body.

9. The package opener in accordance with claim 8 wherein the forward end of the body defines a surface disposed at an angle in a range between about 30 degrees to about 90 degrees relative to an axis defined generally along the length of the body.

10. The package opener in accordance with claim 1 further comprising a tape cutter attached to the body.

11. The package opener in accordance with claim 1 wherein the body defines a bottom opening for receiving a portion of the lever during a cutting process.

12. The package opener in accordance with claim 1 wherein the body defines a bottom opening in a sidewall thereof, a portion of the lever extending into the bottom opening when the first and second cutting blades are in the open position.

13. A package opener comprising:
an elongated body having a first cutting blade fixedly attached thereto,
a second cutting blade rotatably coupled to the body adjacent the first cutting blade,
the first and second cutting blades each having lower portions housed within the body and defining opposing first and second cutting edges respectively,
the first and second cutting blades movable relative to each other between open and closed positions,
the first and second cutting blades cooperating in the open position to define a blade opening between the cutting edges thereof for receiving an object to be cut therein,
a lever attached to the second cutting blade for moving the second cutting blade towards the closed position,
the lever biased for urging the second cutting blade towards the open position,
the first and second cutting edges being disposed generally perpendicular to the length of the body and to a length of the lower portion of the corresponding cutting blade.

14. The package opener in accordance with claim 13 wherein the blade opening between the first and second cutting edges is in a range of about two millimeters to about five millimeters in the open position.

15. The package opener in accordance with claim 1 wherein the blade opening between the first and second cutting edges is generally rectangular in shape.

16. The package opener in accordance with claim 1 wherein the blade opening between the first and second cutting edges is about two millimeters in the open position.

17. The package opener in accordance with claim 13 further comprising a screwdriver.

18. The package opener in accordance with claim 13 wherein the second cutting blade is housed entirely within the body in the open position.

19. The package opener in accordance with claim 13 wherein the body includes the first and second cutting blades coupled to the body near a forward end thereof, the forward end of the body defining a surface disposed at an angle of about 45 degrees relative to an axis defined generally along the length of the body.
